(19) United States
(12) Patent Application Publication
(10) Pub. No.: US 2006/0016670 A1
(43) Pub. Date: Jan. 26, 2006

(54) Prefabricated conveyor belt patch apparatus

(76) Inventor: Dana Perkins, Tilton, NH (US)

Correspondence Address: William B. Ritchie;Law Office of William B. Ritchie, 43 Jackson Street, Concord, NH, 03301, US

(21) Appl. No.: 11/183,656

(22) Filed: Jul. 18, 2005

Related U.S. Application Data
(60) Provisional application No. 60/589,420, filed on Jul. 20, 2004.

(51) Int. Cl. B65G 17/00

(52) U.S. Cl. 198/844.2

(57) ABSTRACT

A kit for patching worn areas in a conveyor belt. Pre-sized patches that include attached hardware are provided. A template that corresponds to the size of the patch is used to remove the worn area so that the patch can be inserted. Once the proper size hole is made in the conveyor belt, fasteners first serve as a template for drilling holds for the anchoring bolts and then serve to hold the patch firmly in place once the bolts have been inserted and locked into position. The kit also features a patch for fixing worn edges. The patches in the kit can be either made from the same material as the conveyor belt used in conjunction with gap tape or from urethane which has an integral skirt that serves the same function as the gap tape.

This application claims benefit of priority under 35 U.S.C. §119(e) to U.S. Provisional Application Ser. No. 60/589,420, filed on Jul. 20, 2004.

### FIELD OF THE INVENTION

This invention relates to conveyor belts, in particular to repairing same in the field.

### BACKGROUND OF THE INVENTION

Transporting materials from one to another is the heart of enabling an assembly line to function. Since the assembly line was invented by Eli Whitney and used to make muskets for the U.S. military, the key to making products less expensively has frequently been the use of conveyor belts as at least part of the assembly line process.

Whether it is moving raw materials, the mail, and even people, conveyors play a vital role in a modern industrialized society and are so ubiquitous, they are often unnoticed in the industrial landscape. Further, the basic technology is changed little over the years. A continuous loop of conveyor material rotates over two axles. The axles are powered to cause the belt to move around, either clockwise or counterclockwise, so that anything that is to be placed thereon will be moved in a linear fashion. The conveyor surface can be horizontal, vertical or at an angle in between. Conveyor belts with regular spaced partitions are often called elevators. Conveyor belts can be used to load or unload materials such as cement, coal, grain, ore and so on. They can range in axle to axle length of several feet to more 60 miles long used in the phosphate mines in Bu Craa in the Western Sahara to carry the ore to the coast south of Laayoune.

While the invention has applications to virtually all such conveyor systems, the use in rock crushing conveyor belts will be used as an example.

The belts used on such systems such as manufactured by Metso Minerals of Milwaukee, Wis., are typically tough multi-ply rubber belts, built to withstand the harsh working environment. Despite the sturdiness of the construction of the belts, eventually one or more holes will develop. If allowed to go un-repaired, the repairable hole will eventually cause the belt to be broken, perhaps needing total replacement. Operators are then faced with the cost of shutting down the conveyor with the resultant loss of production time necessary to effectuate the repair or risk to continued operation until the time when the machine is stopped for the day. Of course, if crushing operations are run in three shifts, the down time condition will never be reached until the belt finally breaks and the machine must be stopped.

Present methods of fixing holes or severely worn spots in the conveyor belt involve cutting out the bad spot and then cutting a patch to fix it. The matching of a patch to repair a hole is difficult as it must be done accurately or the patch will not fit properly. If the hole that is cut into the belt is too small relative to the patch, the patch will not stay flush with the conveyor and more damage to the belt is inevitable. If the hole is too large relative to the patch, the patch is liable to leak, again resulting in further wear or breakage to the conveyor belt or other components of the system.

There is presently no method of quickly and efficiently repairing conveyor belts, especially when the repair must be conducted in an awkward to reach place. In order to minimize production down time, the method of repair must be able to be accomplished quickly and accurately in belts that can have varying sizes of holes and worn regions.

### SUMMARY OF THE INVENTION

It is an aspect of the invention to provide a prefabricated conveyor belt patch apparatus that is available in various sizes and thicknesses in order to meet the repair requirements for a variety of conveyor belts and repair situations.

Another aspect of the invention is to provide a prefabricated conveyor belt patch apparatus that is packaged with a corresponding template for cutting a precise hole in the damaged belt so that the patch fits perfectly without the need for guessing or measuring.

Still another aspect of the invention is to provide a prefabricated conveyor belt patch apparatus such that the apparatus serves as its own template for drilling fastening holes through the belt whereby the patch can be firmly anchored to the conveyor belt that is being repaired.

It is an aspect of the invention to provide a prefabricated conveyor belt patch apparatus that has a plurality of spacers that hold the patch firmly during the drilling process as well as holding the patch centered within the hole that is to be patched.

Another aspect of the invention is to provide a prefabricated conveyor belt patch apparatus that has gap tape fastened to the patch to ensure that the patch will not leak.

Still another aspect of the invention is to provide a prefabricated conveyor belt patch apparatus that has a skive which will help keep the gap tape flush to the top of the patch and provide the proper overhang to overlap the patch onto the conveyor belt that is being repaired.

Still another aspect of the invention is to provide pre-attached clips for attaching the patch to the conveyor belt.

Another aspect of the invention is to provide a prefabricated conveyor belt patch apparatus that is adapted for edge repair of a damaged conveyor belt.

Still another aspect of the invention is to provide a prefabricated conveyor belt patch apparatus for edge repair that has a tapered edge so that the repaired belt is less likely to have the patch catching and tearing on any parts that the belt may encounter while traveling around the axles.

Another aspect of the invention is to provide a prefabricated conveyor belt patch apparatus that includes double wide clips that will match the same spacing pattern of the conveyor belt splice clips. This will enable the patch to be used adjacent to conveyor belt splices such that the gaps between the patch and conveyor belt are eliminated.

These and other aspects of the invention will become apparent in light of the detailed description of the invention which follows.

### BRIEF DESCRIPTION OF THE DRAWINGS

FIG. 1 is a side of the prefabricated conveyor belt patch apparatus in accordance with the invention.

FIG. 2 is top view.

FIG. 3 is a bottom view.

FIG. 4 is top view of an alternative embodiment of the invention.

FIG. 5 is a bottom view of the alternative embodiment.

FIG. 6 is a view of the double wide fastener.

FIG. 7 is a top view of a second alternative embodiment of the invention using double wide fasteners.

FIG. 8 is a bottom view of the alternative embodiment shown in FIG. 7.

FIG. 9 is top view of a third alternative embodiment of the invention.

FIG. 10 is a bottom view of the third alternative embodiment shown in FIG. 9.

FIG. 11 is a side view of another alternative embodiment of the invention.

FIG. 12 is a detailed view of the skive indicated in FIG. 11.

FIG. 13 is a detailed view of the spacers indicated in FIG. 3.

### DETAILED DESCRIPTION OF THE INVENTION

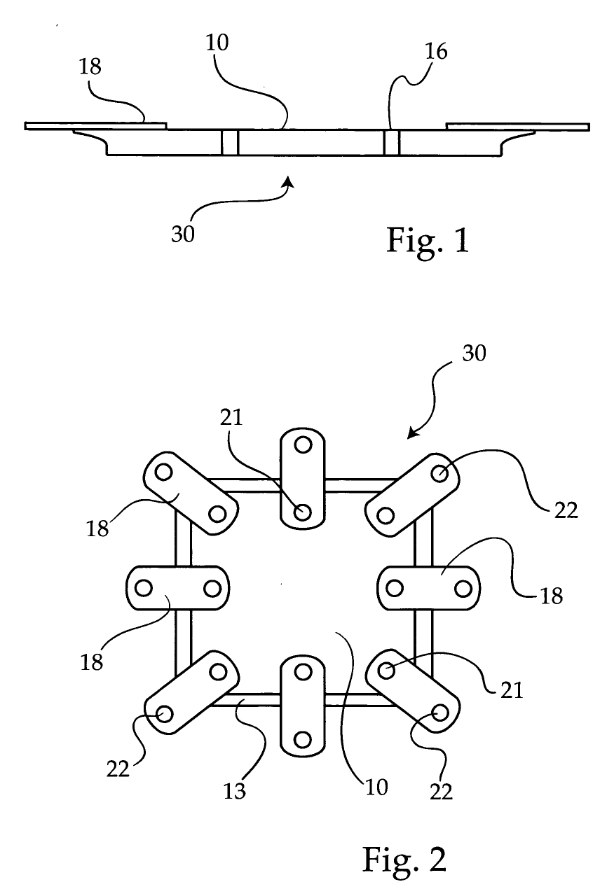

Referring now to FIGS. 1-3, invention 30 is illustrated. The invention is a kit which includes prefabricated patches of at least one size and thickness as well as a cutting template (not shown) that is used to cut a hole in the conveyor belt that is larger than the defect such that the patch selected will fit properly. The cutting template could be disposable such as might be made from poster board. The cutting template could also be made to be used over and over again such as might be made from thin metal. Each sized patch must have a corresponding template.

Patch 10 is preferably made from eurethane or from the same materials as the conveyor belt that is to be repaired. However, materials that are more or less durable would also suffice. Further, the patch 10 should be substantially the same thickness as the thickness of the conveyor belt being repaired. As noted above, the main patch 10 is slightly smaller that the hole made in the conveyor so that the thin skirt integral with and surrounding patch 10 seals the area between the larger hole made in the conveyor belt so that when patch 10 is secured into place it will be flat relative to the surface of the conveyor belt.

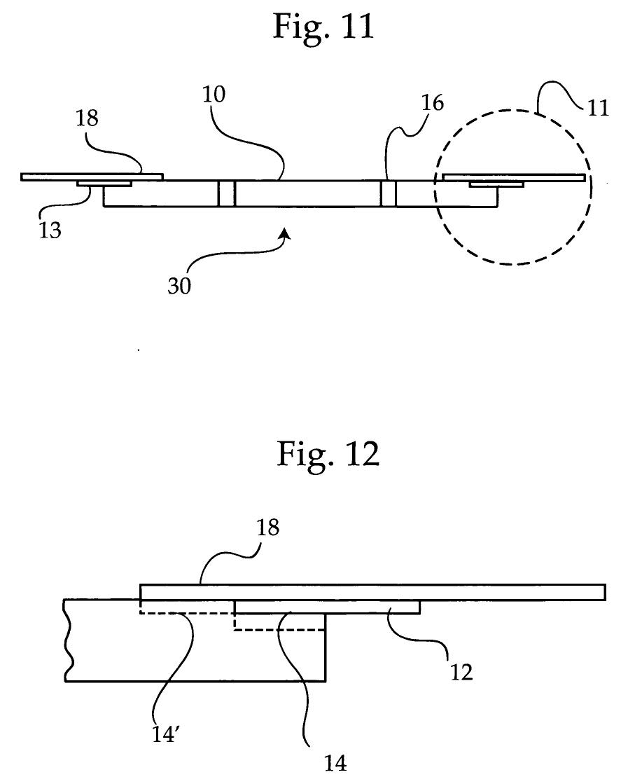

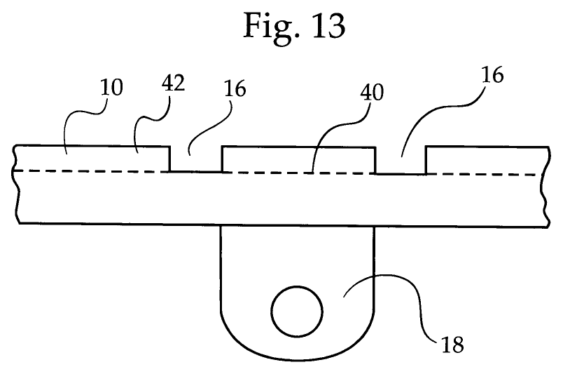

As shown in FIG. 11, an alternative embodiment, gap tape 13 is attached at the perimeter of patch 10 which seals the gap between the conveyor belt and patch 10 to ensure that material being conveyed will not leak through. Gap tape 13 is preferably the type of tape that is sold by Flexco of Downers Grove, Ill. under the brand name FLEXCO-LOK tape. As shown in detail in FIG. 11, Skive 14 is cut into patch 10 so that gap tape 13 is flush with the top surface of patch 10 as shown, Thus, the depth of skive 14 is preferably the thickness of gap tape 13. Optionally, skive 14′ could also be cut so that both gap tape 13 and fastener 18 would be recessed thus fastener 18 would be flush with the surface of patch 10 even prior to when the invention is tightened into place. Thus, the depth of skive 14′ under the fastener 18 would correspond to the thickness of fastener 18 and the depth of skive 14′ under gap tape 13 would correspond the thickness of fastener 18 plus the thickness of gap tape 13.

Fasteners 18 are pre-attached to patch 10 via glue or other attachment means well known in the art. Bolt openings 22 first serve as a template by which holes are drilled through the conveyor belt and then invention 10 can be fastened to patch 10 via a clip and bolts (not shown) which are fed through openings 22 and 21. The bolts are then tightened into position via specialized nuts (not shown). The specialized bolts and nuts are well known in the art and are manufactured and sold by Flexco.

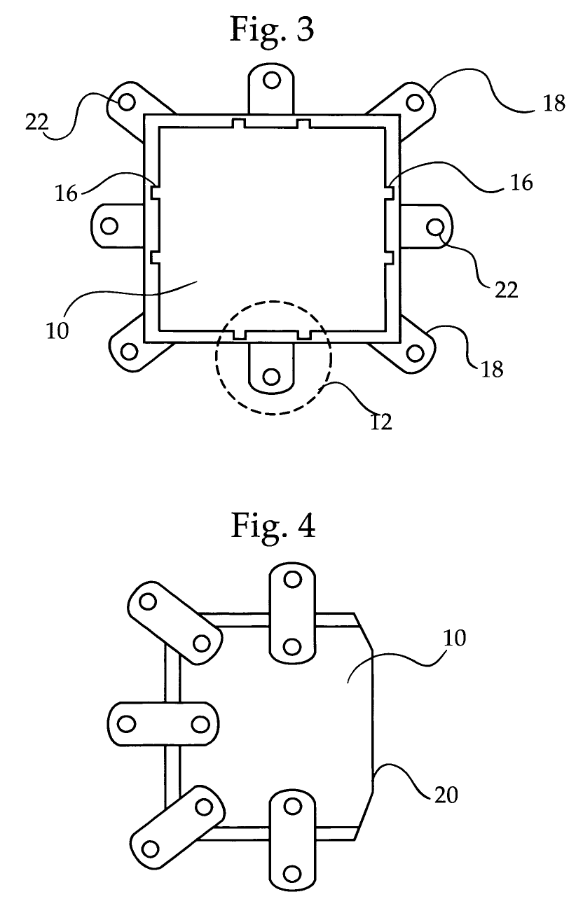

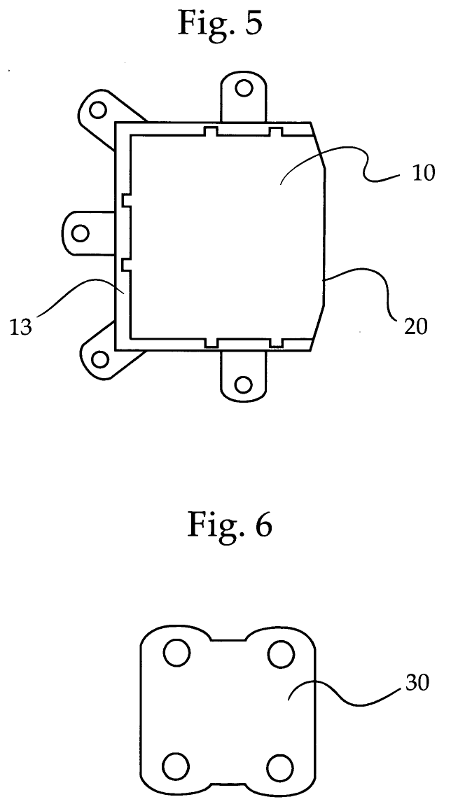

As shown in FIG. 3, spacers 16 are used to make invention 30 self centering thus ensuring proper installation. Spacers 16 are a plurality of tabs that are designed to position patch 10 properly within hole 40. Spacers 16 provide the proper gap 42 between patch 10 and conveyor belt hole 40 so that invention 30 can be tightened without wrinkling or puckering. This undesirable situation would occur if the patch was too large for the hole or was off center within the perimeter of the hole that has been cut using the hole template discussed above.

As shown in FIGS. 3 and 4, another alternative embodiment is illustrated. This prefabricated patch 31 is used for left and right edge repair. The only difference is that one edge has a taper 20 that helps keep the invention from catching or tearing on any part that the moving conveyor belt passes through during its travel around the axles.

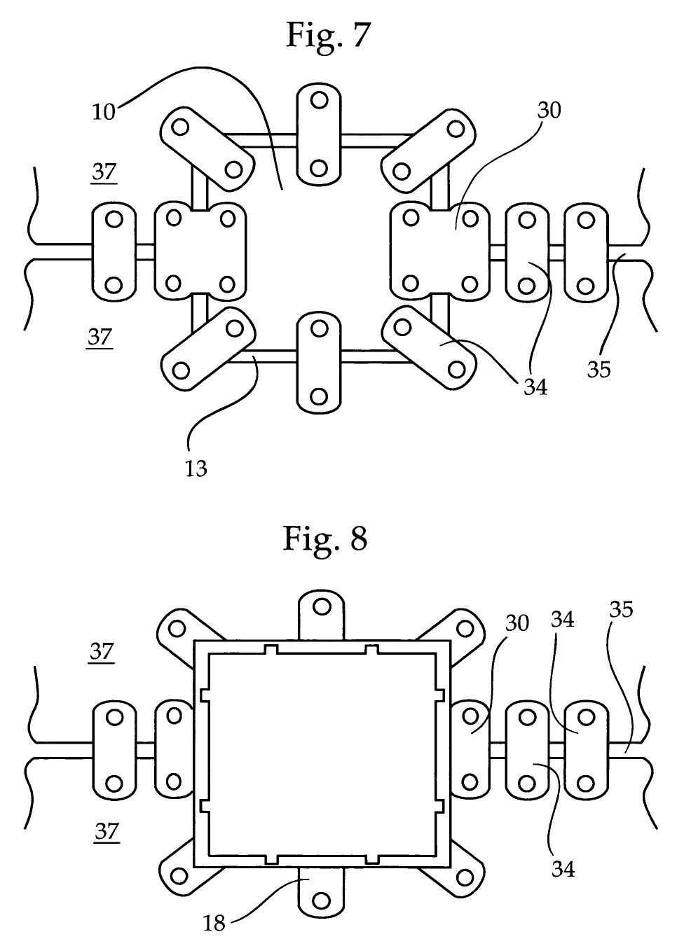

FIG. 4 illustrates a double wide fastener 30 that is used in two other embodiments of the invention. Fastener 30 is preferably metal that is sufficiently durable to withstand the rigors of the task. Fastener 30 enables the invention to be used along conveyor belt splices as well as other locations on the belt. Fasteners 30 permit the repair to maintain strength in the splices 35 shown in FIG. 7 and 8 for example, along with eliminating gaps between patch 10 and the conveyor belt.

FIGS. 7 and 8 show the use of fasteners 30 for a center splice repair of conveyor belt 37. Clips 34 are used to attach conveyor belt 37 together at splice 35. Each fastener 30 replaces a clip 34 so that splice strength is maintained.

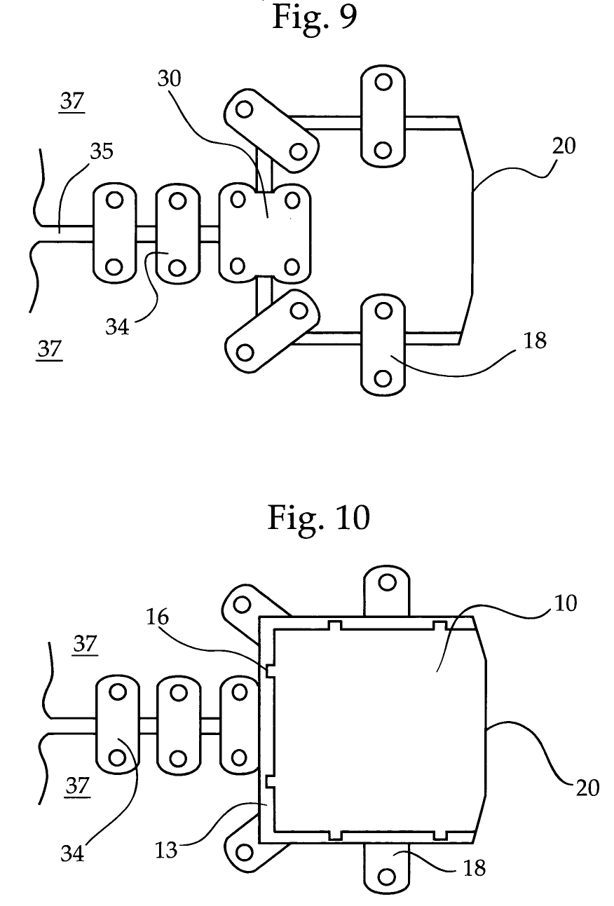

FIGS. 9 and 10 show the use of fasteners 30 for an edge splice. The edge of invention 10 is provided with taper 20 so that, as the embodiment doesn't use double wide fastener 30, helps keep the invention from catching or tearing on any part that the moving conveyor belt passes during its travel around the axles.

In operation, a properly sized hole is made in the belt to remove the defect as has been discussed. Then, patch 10 is aligned within this opening as shown in FIG. 3 and as discussed above. The next step is to drill mounting holes in the conveyor belt that correspond to bolt holes 22 using these holes as the template. The holes in the conveyor belt are made using a specialized boring tools, well known in the art, such as those tools made by Flexco for drilling holes in a conveyor belt. Finally, the bolts and the mating fastener clip are inserted up through the bottom of the conveyor belt into the holes 21 and 22 and tightened with nuts until fastener 18 is substantially flush with the top surface of the conveyor belt and patch 10. The bolts are then broken off flush with the top of the nut and the repair is completed quickly and efficiently.

While certain representative embodiments of the invention have been described herein for the purposes of illustration, it will be apparent to those skilled in the art that modification therein may be made without departure from the spirit and scope of the invention.

What is claimed is:

1. A kit for patching conveyor belts having a worn spot therein, said apparatus comprising:
at least one prefabricated patch having the thickness that corresponds to the thickness of the worn conveyor belt;
a cutting template that is used to cut a hole in the worn belt such that the worn spot is encompassed therein and such that the cutting template corresponds to said at least one prefabricated patch;
a plurality of fasteners having opposing bolt openings pre-attached to said at least one prefabricated patch wherein the bolt openings that align at least one prefabricated patch with conveyor belt first serve as a template and then serve to attach said at least one patch to the conveyor belt using bolts and specialized nuts well known in the art.

2. The kit of claim 1 further comprising a plurality of spacers that position said at least one patch properly within the hole such that a gap between said at least one patch and the conveyor is provided wherein said plurality of fasteners can be tightened without causing wrinkling or puckering of said at least one patch relative to said conveyor belt.

3. The kit of claim 1 wherein said at least one patch is made from urethane having a skirt integrally attached around the perimeter of said at least one patch.

4. The kit of claim 1 where said at least one patch is made from essentially the same material as the conveyor belt and wherein said kit further comprises a gap tape that is attached at the perimeter of said at least one patch 10 which seals the gap between the conveyor belt and said at least one patch to ensure that material being conveyed will not leak through.

5. The kit of claim 4 wherein said gap tape is FLEXCO-LOK brand of tape.

6. A kit for patching conveyor belts having a worn spot on an edge, said apparatus comprising:
at least one prefabricated patch having the thickness that corresponds to the thickness of the worn conveyor belt and having one edge has a taper 20 that helps keep said at least one prefabricated patch from catching or tearing on any part that the moving conveyor belt passes through during its travel around the axles;
a cutting template that is used to cut a hole in the worn belt such that the worn spot is encompassed therein and such that the cutting template corresponds to said at least one prefabricated patch;
a plurality of fasteners having opposing bolt openings pre-attached to said at least one prefabricated patch wherein the bolt openings that align at least one prefabricated patch with conveyor belt first serve as a template and then serve to attach said at least one patch to the conveyor belt using bolts and specialized nuts well known in the art.

7. The kit of claim 6 further comprising a plurality of spacers that position said at least one patch properly within the hole such that a gap between said at least one patch and the conveyor is provided wherein said plurality of fasteners can be tightened without causing wrinkling or puckering of said at least one patch relative to said conveyor belt.

8. The kit of claim 6 wherein said at least one patch is made from urethane having a skirt integrally attached around the perimeter of said at least one patch.

9. The kit of claim 6 where said at least one patch is made from essentially the same material as the conveyor belt and wherein said kit further comprises a gap tape that is attached at the perimeter of said at least one patch 10 which seals the gap between the conveyor belt and said at least one patch to ensure that material being conveyed will not leak through.

10. The kit of claim 9 wherein said gap tape is FLEXCO-LOK brand of tape.
